(19) United States
(12) Patent Application Publication
(10) Pub. No.: US 2026/0066571 A1
(43) Pub. Date: Mar. 5, 2026

(54) CONNECTOR

(71) Applicant: SUMITOMO WIRING SYSTEMS, LTD., Mie (JP)

(72) Inventor: Kenji OI, Mie (JP)

(21) Appl. No.: 19/304,996

(22) Filed: Aug. 20, 2025

(30) Foreign Application Priority Data
Aug. 27, 2024 (JP) 2024-145525

(51) Int. Cl. H01R 13/506; H01R 13/424; H01R 25/16

(52) U.S. Cl. CPC H01R 13/506; H01R 13/424; H01R 25/16

(57) ABSTRACT

A connector 1 includes a connector body 2 mounted with a busbar 6 to be electrically connected to a terminal of a mating connector 4. The connector 1 includes an opening forming portion 12 integrally provided to the connector body 2 and a cover member 3 to be mounted on the connector body 2. The opening forming portion 12 forms a part of an opening 5, in which a tip portion 8 of the busbar 6 is arranged and which serves as a fitting location of the mating connector 4, in the connector body 2. The cover member 3 is formed separately from the connector body 2 and forms the opening 5 together with the opening forming portion 12 when being mounted on the connector body 2.

### CROSS-REFERENCE TO RELATED APPLICATIONS

This application is based on and claims priority from Japanese Patent Application No. 2024-145525, filed on Aug. 27, 2024, with the Japan Patent Office, the disclosure of which is incorporated herein in its entirety by reference.

### TECHNICAL FIELD

The present invention relates to a connector.

### BACKGROUND

Conventionally, an electrical connection box including a connector block insert-molded with busbars is known as disclosed in Japanese Patent No. 6009604. In this electrical connection box, the tips of the busbars are arranged inside receptacles formed in the connector block. A plurality of the receptacles include, for example, fitting openings, into which mating connectors are fit, and are arranged in a width direction of the connector block.

### SUMMARY

The type of the connector block insert-molded with the busbars is determined for each shape of the fitting opening. Thus, if an attempt is made to manufacture different types of connector blocks using an existing facility, the different types of connector blocks cannot be manufactured unless the facility of an existing manufacturing apparatus is largely changed. Then, a significant cost increase is unavoidable, wherefore certain measures have been necessary.

The present disclosure aims to provide a connector which can be manufactured in a plurality of types without requiring a large-scale change of a manufacturing facility.

A connector for solving the above problem is provided with a connector body mounted with a busbar to be electrically connected to a terminal of a mating connector, an opening forming portion integrally provided to the connector body, the opening forming portion forming a part of an opening, a tip portion of the busbar being arranged in the opening, the opening serving as a fitting location of the mating connector, and a cover member formed separately from the connector body, the cover member forming the opening together with the opening forming portion when being mounted on the connector body.

The present disclosure enables a plurality of types of connectors to be manufactured without requiring a large-scale change of a manufacturing facility.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector.

FIG. 2 is a front view showing the shapes of openings of a connector.

FIG. 3 is an exploded perspective view of the connector.

FIG. 4 is a back view of a connector body before a cover member is mounted.

FIG. 5 is a perspective view of the cover member when viewed from behind.

FIG. 6 is a perspective view of the connector body before the cover member is mounted when viewed from front.

FIG. 7 is a vertical section of the connector showing a positioning mechanism.

FIG. 8 is a diagram showing the mounting of busbars into the connector body.

FIG. 9 is a diagram showing the mounting of the cover member on the connector body.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The connector of the present disclosure is provided with a connector body mounted with a busbar to be electrically connected to a terminal of a mating connector, an opening forming portion integrally provided to the connector body, the opening forming portion forming a part of an opening, a tip portion of the busbar being arranged in the opening, the opening serving as a fitting location of the mating connector, and a cover member formed separately from the connector body, the cover member forming the opening together with the opening forming portion when being mounted on the connector body.

According to this configuration, the busbar is separate from the connector body. The opening of the connector is formed by a part of the connector body and a part of the cover member by mounting the cover member on the connector body. Thus, insert molding is not used to manufacture the connector, wherefore a plurality of types of connectors having different opening shapes can be inexpensively manufactured using an existing facility. Therefore, a plurality of types of connectors can be manufactured without requiring a large-scale change of the manufacturing facility.
[2] In [1] described above, a mounting direction of the cover member on the connector body is a direction along an extension direction of the tip portion of the busbar, and a supporting mechanism for supporting the cover member mounted on the connector body in a plane direction intersecting the mounting direction of the cover member is provided between the connector body and the cover member. According to this configuration, even if the mating connector fit in the opening is pried, that operation load can be supported by the supporting mechanism. Therefore, the detachment of the cover member mounted on the connector body can be made difficult.
[3] In [2] described above, the supporting mechanism includes a guiding portion for guiding insertion of the cover member into the connector body by a rail shape when the cover member is mounted to be inserted into the connector body. According to this configuration, the cover member can be smoothly mounted on the connector body by being guided by the guiding portion.
[4] In any one of [1] to [3] described above, the connector is provided with a lock mechanism for holding the cover member on the connector body when the cover member is mounted on the connector body. According to this configuration, the cover member mounted on the connector body can be firmly fixed by the lock mechanism. Thus, the detachment of the cover member from the connector body can be made difficult.
[5] In anyone of [1] to [4] described above, the cover member includes a support wall for supporting the tip portion of the busbar in a positioned state. According to this configuration, the busbar can be positioned at an optimal position by the support wall of the cover member. Thus, the terminal of the mating connector and the busbar can be smoothly connected when the mating connector is fit into the opening.
[6] In [5] described above, the busbar includes an intersecting portion extending in a direction intersecting the tip portion on a base end of the tip portion, a mounting direction of the busbar into the connector body is a direction along an extension direction of the intersecting portion of the busbar, and the support wall projects along the mounting direction of the busbar into the connector body. According to this configuration, since the busbar is supported by the support wall of the cover member along the mounting direction of the busbar into the connector body, the busbar mounted in the connector body can be made difficult to come out from the connector body.
[7] In any one of [1] to [6] described above, the connector is provided with a positioning mechanism including a projection provided on one of the connector body and the busbar and a recess provided in the other of the connector body and the busbar, the positioning mechanism positioning the busbar with respect to the connector body by engaging the projection and the recess when the busbar is mounted into the connector body. According to this configuration, the busbar mounted in the connector body can be made difficult to come out from the connector body by the positioning mechanism.

### DETAILS OF EMBODIMENT OF PRESENT DISCLOSURE

A specific example of the present disclosure is described below with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one.

### (Connector 1)

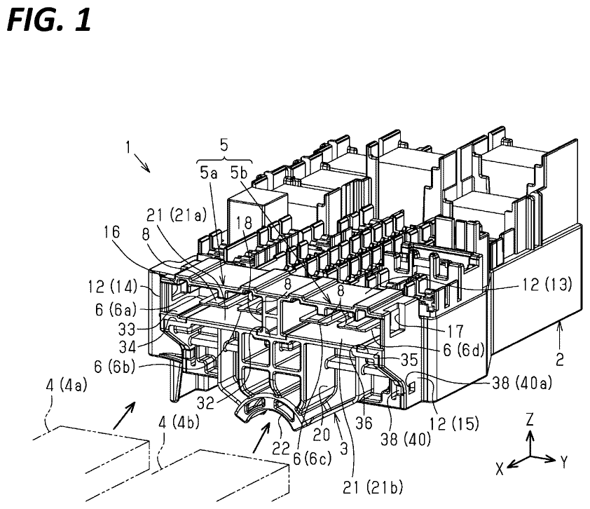

As shown in FIG. 1, a connector 1 is provided with a connector body 2 forming a body part of the connector 1 and a cover member 3 used by being mounted on the connector body 2. The connector 1 is, for example, an electrical connection box (junction box) in which electrical components such as a rely and a fuse (both not shown) are arranged in the connector body 2. The connector 1 is, for example, used in a vehicle. In the case of being used in the vehicle, the connector 1 is arranged on the foot of a seat in the vehicle or the like. The connector body 2 and the cover member 3 are, for example, made of resin.

The connector 1 is provided with openings 5 serving as fitting locations of mating connectors 4 to be electrically connected. The openings 5 are formed by the connector body 2 and the cover member 3. In this example, a plurality of (two in this example) the openings 5 are provided side by side in a width direction (Y-axis direction of FIG. 1) of the connector 1. The openings 5 of this example include a first opening 5a, into which a first mating connector 4a is fit, and a second opening 5b, into which a second mating connector 4b is fit. Busbars 6 connected to the relay, the fuse and the like arranged in the connector body 2 are mounted in the connector body 2. Terminals (not shown) of the mating connector 4 are electrically connected to the busbars 6 of the connector 1 when the mating connector 4 is fit into the opening 5.

### (Busbars 6)

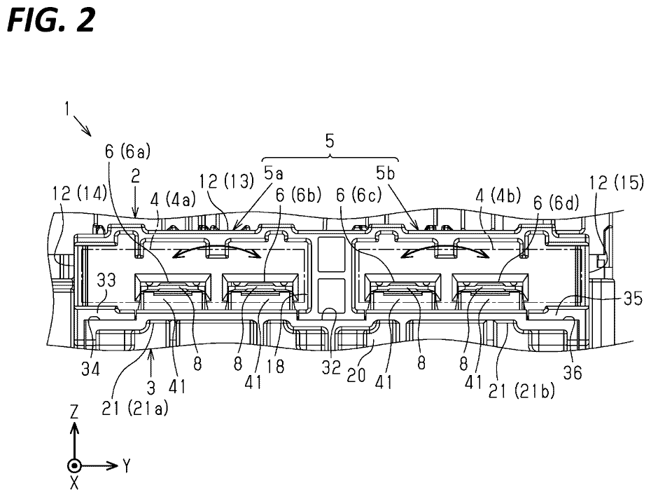

As shown in FIGS. 1 and 2, a plurality of (four in this example) the busbars 6 are provided side by side in the width direction (Y-axis direction of FIG. 1 and the like) of the connector 1 in this example. The plurality of busbars 6 are, for example, provided for each function and each type of an in-vehicle device. In the case of this example, a first busbar 6a, a second busbar 6b, a third busbar 6c and a fourth busbar 6d are arranged in this order from a left side in figures.

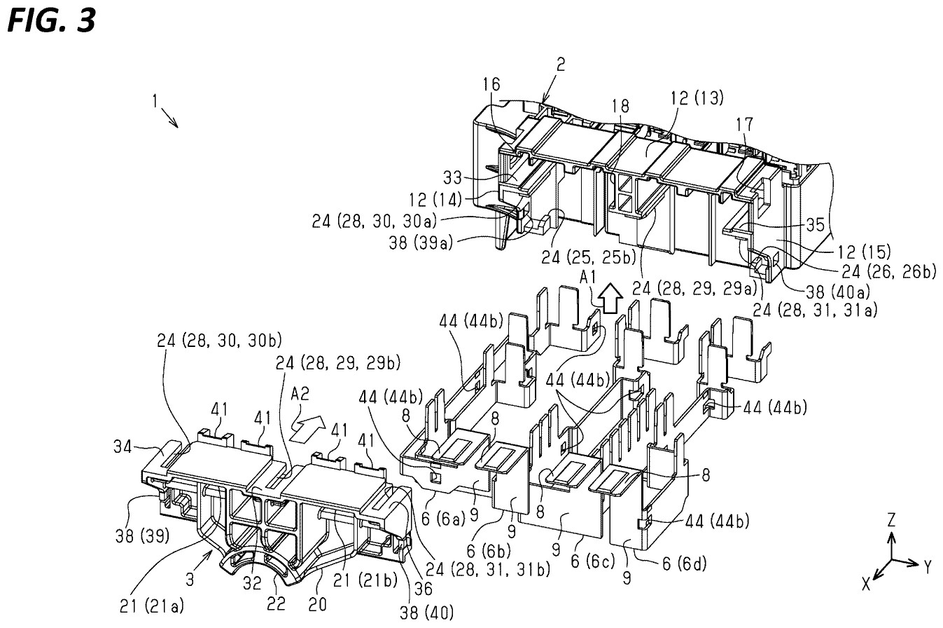

As shown in FIG. 3, the busbar 6 includes a tip portion 8 to be brought into contact with the terminal of the mating connector 4 when the mating connector 4 is fit into the opening 5, and an intersecting portion 9 extending in a direction intersecting the tip portion 8 on the base end of the tip portion 8. The tip portion 8 of this example extends along a mounting direction (−X-axis direction of FIG. 3) when the cover member 3 is mounted on the connector body 2. The tip portion 8 of this example is orthogonal to the intersecting portion 9. As just described, the tip of the busbar 6 is formed into a shape bent substantially at 90°. The intersecting portion 9 of this example means, for example, a part formed by bending the base end of the tip portion 8 substantially at 90° in a metal plate of the busbar 6 in the form of a long plate.

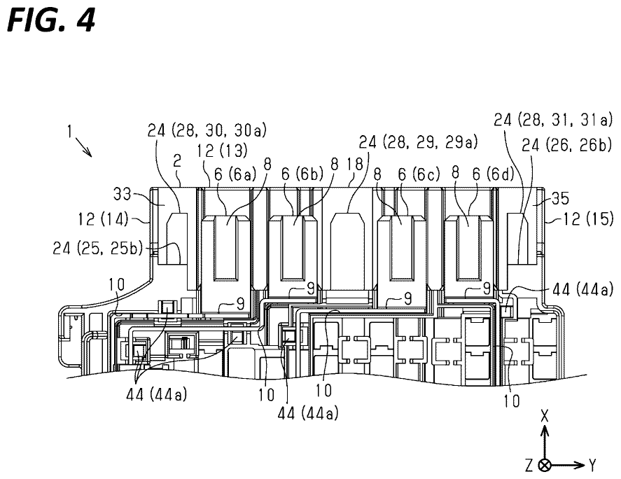

As shown in FIG. 4, the busbar 6 is accommodated in a groove-like busbar accommodating portion 10 formed in the connector body 2. The busbar accommodating portion 10 is provided for each of the first to fourth busbars 6a to 6d. A mounting direction of the busbar 6 into the connector body 2 is a direction (direction of an arrow A1 of FIG. 3) along an extension direction of the intersecting portion 9 of the busbar 6. The busbar 6 is, for example, formed by bending an elongated metal plate halfway a plurality of times.

### (Opening Forming Portion 12)

As shown in FIG. 3, the connector body 2 is provided with an opening forming portion 12 forming parts of the openings 5 serving the fitting locations of the mating connectors 4. The opening forming portion 12 is integrally formed to the connector body 2. The opening forming portion 12 is shaped such that a surface, through which the cover member 3 is inserted (left surface shown in FIG. 3), and a surface intersecting this surface (lower surface shown in FIG. 3) are open.

The opening forming portion 12 of this example includes a first wall 13 formed in a direction (direction of an X-Y plane of FIG. 3) to cover the inside of the opening forming portion 12, a second wall 14 arranged on one end of the first wall 13 and extending in a direction intersecting the first wall 13 and a third wall 15 arranged on the other end of the first wall 13 and formed in parallel to the second wall 14. A space surrounded by the first, second and third walls 13, 14, 15 serves as a fitting region for the mating connectors 4. The second wall 14 is formed with a locked groove 16, into which a lock piece (not shown) of the first mating connector 4a is fit. The third wall 15 is formed with a locked groove 17, into which a lock piece (not shown) of the second mating connector 4b is fit.

As shown in FIGS. 1 and 2, the openings 5 are divided as the first opening 5a and the second opening 5b by forming a partitioning portion 18 in a center of the inner surface of the first wall 13. The first and second openings 5a, 5b are arranged side by side in an arrangement direction (Y-axis direction of FIG. 1 and the like) of the busbars 6. In the case of this example, the tips of the first and second busbars 6a, 6b are arranged inside the first opening 5a and the tips of the third and fourth busbars 6c, 6d are arranged inside the second opening 5b.

### (Cover Member 3)

As shown in FIG. 3, the cover member 3 is formed separately from the connector body 2 and forms the openings 5 together with the opening forming portion 12 when being mounted on the connector body 2. The cover member 3 includes a body portion 20 and an opening forming wall 21 arranged at a position facing the opening forming portion 12 of the connector body 2 in the body portion 20. The body portion 20 is formed into a lightened shape satisfying both strength and weight saving.

The opening forming wall 21 includes a first forming wall 21a forming some walls of the first opening 5a and a second forming wall 21b forming some walls of the second opening 5b. The first and second forming walls 21a, 21b are formed into a planar shape along a plane (X-Y axis plane of FIG. 3) in the mounting direction of the cover member 3 on the connector body 2.

The mounting direction of the cover member 3 on the connector body 2 is a direction (direction of an arrow A2 of FIG. 3) along an extension direction of the tip portions 8 of the busbars 6. The cover member 3 is mounted on the connector body 2 to be mostly accommodated in the opening forming portion 12. The first opening 5a is a region surrounded by a part of the first wall 13, the second wall 14, the partitioning portion 18 and the first forming wall 21a. The second opening 5b is a region surrounded by a part of the first wall 13, the third wall 15, the partitioning portion 18 and the second forming wall 21b.

The cover member 3 includes a wire passing portion 22 in which wires (not shown) electrically connected to the busbars 6 and pulled out from the connector 1 are arranged. The wire passing portion 22 is, for example, arranged on a side opposite to the opening forming wall 21 in the body portion 20 and formed into an arcuate shape. The respective wires (not shown) connected to the respective busbars 6 are arranged in the wire passing portion 22. These wires are, for example, bundled together with the wire passing portion 22 by a zip tie (not shown).

### (Supporting Mechanism 24)

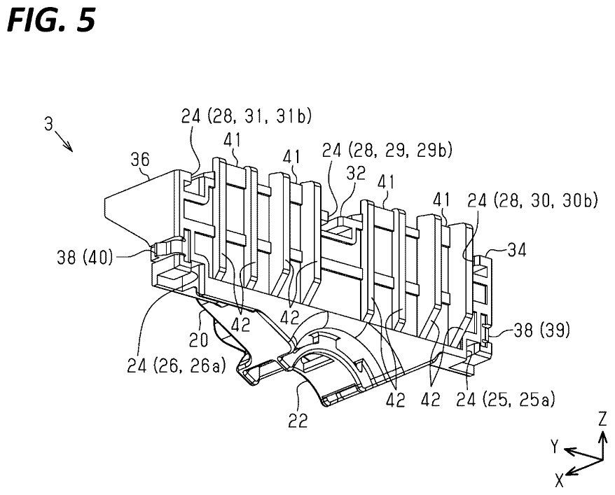

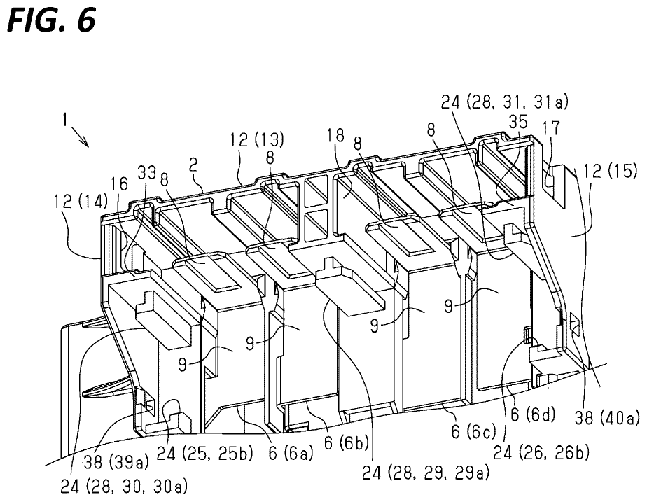

As shown in FIGS. 5 and 6, a supporting mechanism 24 for supporting the cover member 3 mounted on the connector body 2 in a plane direction (Y-Z plane direction of FIG. 5) intersecting the mounting direction (−X-axis direction of FIG. 5) of the cover member 3. The supporting mechanism 24 of this example includes a first supporting portion 25 for supporting one end in the width direction (Y-axis direction of FIG. 5) of the connector 1 and a second supporting portion 26 for supporting the other end in the width direction of the connector 1.

The first supporting portion 25 includes a recess 25a (see FIG. 5) formed in a corner part of the cover member 3 and a projection-like portion 25b (see FIG. 6) formed on the connector body 2. The projection-like portion 25b is formed into a substantially laterally inverted L shape on the inner surface of the second wall 14 of the connector body 2. Similarly to the first supporting portion 25, the second supporting portion 26 includes a recess 26a and a projection-like portion 26b. The projection-like portion 26b is formed into a substantially L shape on the inner surface of the third wall 15 of the connector body 2.

The projection-like portions 25b, 26b support the cover member 3 fit into the recesses 25a, 25b from below. That is, the first and second supporting portions 25, 26 support the cover member 3 mounted on the connector body 2 in a plane direction intersecting the mounting direction of the cover member 3 on the connector body 2, in other words, in an operation direction of a prying operation of the mating connector 4 connected to the connector 1. The prying operation is, for example, an operation of twisting the mating connector 4 fit in the opening 5.

### (Guiding Portions 28)

As shown in FIGS. 3, 5 and 6, the supporting mechanism 24 includes guiding portions 28 for guiding the insertion of the cover member 3 into the connector body 2 by a rail shape when the cover member 3 is mounted to be inserted into the connector body 2. The guiding portions 28 of this example include a first guiding portion 29 arranged in a center in the width direction (lateral direction in figures) of the connector 1, a second guiding portion 30 arranged on one end in the width direction and a third guiding portion 31 arranged on the other end in the width direction.

The first guiding portion 29 includes a rail projection 29a formed on the connector body 2 and a rail groove 29b formed in the cover member 3 to be engaged with the rail projection 29a. The rail projection 29a is formed on the tip of the partitioning portion 18. The rail groove 29b is formed in a recessed portion 32 lower than the first and second forming walls 21a, 21b.

Similarly to the first guiding portion 29, the second guiding portion 30 includes a rail projection 30a and a rail groove 30b. The rail projection 30a is formed on the lower surface of a projecting plate 33 projecting laterally from the inner surface of the second wall 14. The rail groove 30b is formed in a recessed portion 34 lower than the first forming wall 21a on one end of the cover member 3 in a direction intersecting the mounting direction of the cover member 3 on the connector body 2.

Similarly to the first guiding portion 29, the third guiding portion 31 includes a rail projection 31a and a rail groove 31b. The rail projection 31a is formed on the lower surface of a projecting plate 35 projecting laterally from the inner surface of the third wall 15. The rail groove 31b is formed in a recessed portion 36 lower than the second forming wall 21b on the other end of the cover member 3 in the direction intersecting the mounting direction of the cover member 3 on the connector body 2.

The guiding portions 28 guide the mounting of the cover member 3 on the connector body 2 by the rail shapes of the first, second and third guiding portions 29, 30 and 31. Further, the guiding portions 28 support the cover member 3 mounted on the connector body 2 in the plane direction intersecting the mounting direction of the cover member 3 on the connector body 2 by the planar shapes of the rail projection 31a and the rail groove 31b. That is, the guiding portions 28 support the cover member 3 against an operation load when the mating connector 4 connected to the connector 1 is pried.

### (Lock Mechanism 38)

As shown in FIGS. 3,5 and 6, the connector 1 is provided with a lock mechanism 38 for holding the cover member 3 on the connector body 2 when the cover member 3 is mounted on the connector body 2. The lock mechanism 38 of this example includes a first lock portion 39 formed on a side surface of the cover member 3 and a second lock portion 40 formed on a side surface different from the one for the first lock portion 39 in the cover member 3. The first lock portion 39 is arranged on one side surface of the body portion 20. The second lock portion 40 is arranged on the other side surface opposite to one side surface in the body portion 20. The first and second lock portions 39, 40 are resilient pieces each including a protrusion on a tip.

The lock mechanism 38 includes a first lock groove 39a to be engaged with the first lock portion 39 and a second lock groove 40a to be engaged with the second lock portion 40. The first lock groove 39a is a hole formed in the second wall 14. The second lock groove 40a is a hole formed in the third wall 15. The lock mechanism 38 holds the cover member 3 on the connector body 2 by locking the first lock portion 39 into the first lock groove 39a and locking the second lock portion 40 into the second lock groove 40a.

### (Support Walls 41)

As shown in FIGS. 2,4 and 6, the cover member 3 includes support walls 41 for supporting the tip portions 8 of the busbars 6 in a positioned state. The support wall 41 projects along the mounting direction of the busbar 6 into the connector body 2. A total of four support walls 41 of this example are formed for supporting the tip portion 8 of the first busbar 6a, for supporting the tip portion 8 of the second busbar 6b, for supporting the tip portion 8 of the second busbar 6c and for supporting the tip portion 8 of the fourth busbar 6d.

### (Back Surface Shape of Cover Member 3)

As shown in FIG. 5, busbar contact portions 42 for contacting the intersecting portions 9 of the busbars 6 mounted in the connector body 2 are formed on the back surface of the cover member 3. The busbar contact portion 42 is composed of a pair of projecting walls extending in a direction orthogonal to the mounting direction of the cover member 3 on the connector body 2 and arranged to face each other. A total of four busbar contact portions 42 of this example are formed for contacting the intersecting portion 9 of the first busbar 6a, for contacting the intersecting portion 9 of the second busbar 6b, for contacting the intersecting portion 9 of the third busbar 6c and for contacting the intersecting portion 9 of the fourth busbar 6d.

### (Positioning Mechanisms 44)

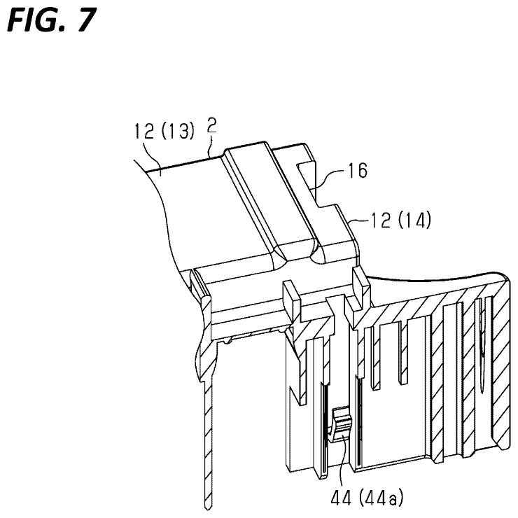

As shown in FIG. 7, the connector 1 is provided with positioning mechanisms 44 for positioning the busbars 6 in the connector body 2. The positioning mechanism 44 includes, for example, a projection 44a formed on one of the connector body 2 and the busbar 6 and a recess 44b (see FIG. 3 and the like) formed in the other of these. The positioning mechanism 44 positions the busbar 6 with respect to the connector body 2 by engaging the projection 44a and the recess 44b when the busbar 6 is mounted into the connector body 2.

Note that, in the positioning mechanism 44 shown in FIG. 7, the connector body 2 is formed with the projection 44a and the busbar 6 is formed with the recess 44b. Further, the positioning mechanism 44 shown in FIG. 7 is for positioning the first busbar 6a, and similar positioning mechanisms 44 are also provided for the second, third and fourth busbars 6b, 6c and 6d. The number of the positioning mechanisms 44, i.e. the number of pairs of the projection 44 and the recess 44b, for one busbar 6 is not limited to one and a plurality of the positioning mechanisms 44 are preferably formed.

### [Functions]

Next, functions of the connector 1 of this embodiment are described.

### (Assembly Procedure of Components)

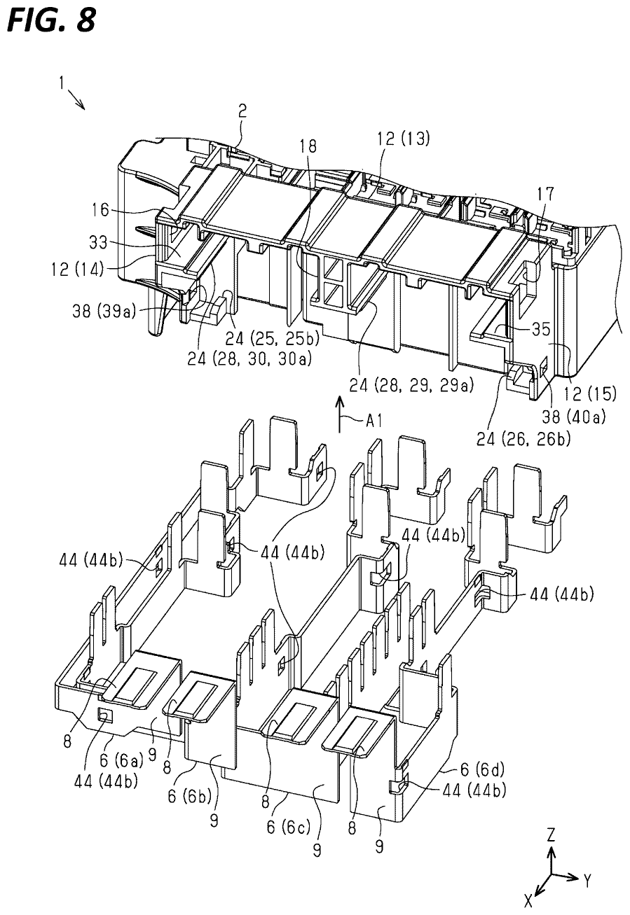

As shown in FIG. 8, the busbars 6 are first mounted into the connector 1. In the case of this example, the busbar 6 is mounted to be inserted into the busbar accommodating portion 10 formed in the connector body 2. Particularly, the busbar 6 of this example is mounted into the busbar accommodating portion 10 of the connector body 2 by being inserted in a thickness direction (direction of an arrow A1 of FIG. 8) of the connector body 2. Further, the first to fourth busbars 6a to 6d are respectively inserted into the paired busbar accommodating portions 10.

Each busbar 6 is positioned by the positioning mechanism 44 when being inserted into the busbar accommodating portion 10. Specifically, the recess 44b formed in the busbar 6 is engaged with the projection 44a of the connector body 2. In this way, the position of the busbar 6 is fixed in the busbar accommodating portion 10, wherefore the busbar 6 hardly comes out from the busbar accommodating portion 10.

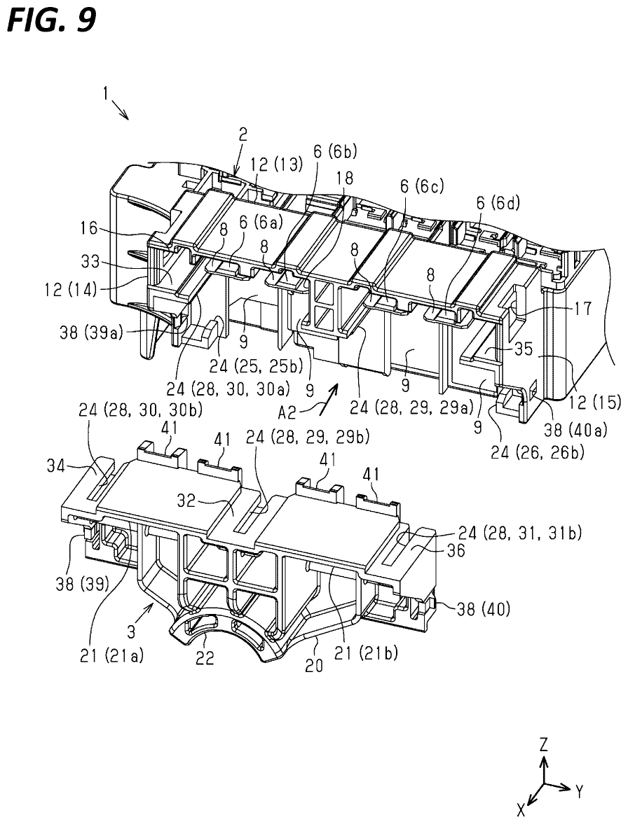

As shown in FIG. 9, after the busbars 6 are mounted, the cover member 3 is mounted on the connector body 2. The cover member 3 is inserted into the connector body 2 along a direction (direction of an arrow A2 of FIG. 9) orthogonal to an insertion direction of the busbars 6 into the connector body 2 (+Z-axis direction of FIG. 9). In the case of this example, the insertion of the cover member 3 into the connector body 2 is guided by the guiding portions 28. That is, since an operation of inserting the cover member 3 into the connector body 2 is guided by the guiding portions 28, the cover member 3 can be smoothly inserted into the connector body 2.

As shown in FIG. 1, if the cover member 3 is pushed deep into the connector body 2, the position of the cover member 3 is locked by the lock mechanism 38. Specifically, the first and second lock portions 39, 40 of the cover member 3 are respectively engaged with the first and second lock grooves 39a, 40a of the connector body 2, whereby the position of the cover member 3 is fixed. If the cover member 3 is mounted on the connector body 2, the openings 5 for connecting the mating connectors 4 are formed by the opening forming portion 12 of the connector body 2 and the opening forming wall 21 of the cover member 3. In the case of this example, the first mating connector 4a is connected to the first opening 5a and the second mating connector 4b is connected to the second opening 5b in these openings 5.

As shown in FIG. 2, prying forces in directions of arrows of FIG. 2 may be applied to the first and second mating connectors 4a, 4b. In the case of this example, since the cover member 3 is supported by the supporting mechanism 24, an operation load of a prying operation can be supported by the supporting mechanism 24. Thus, even if the first or second mating connector 4a, 4b is pried, the cover member 3 is hardly detached from the connector body 2.

(Comparison of Conventional Art and this Example)

The connector 1 of this type is often manufactured by insert molding for integrally forming the busbars 6 and a resin. A manufacturing apparatus for insert molding is necessary for each type of the connector 1. Further, in the connector 1, the shapes of the openings 5 are determined according to the type. Thus, if an attempt is made to manufacture connectors 1 having different opening shapes by insert molding, manufacturing apparatuses for those types need to be prepared, wherefore it requires significant cost.

On the other hand, in the case of this example, the busbars 6 are mounted into the connector body 2, openings of the connector body 2 are partially cut, and the cover member 3 formed separately is mounted on the connector body 2, thereby forming the openings 5, into which the mating connectors 4 are fit. As just described, the connector 1 is manufactured without using insert molding. Thus, even if connectors 1 having different opening shapes are necessary, the desired connectors 1 can be obtained by manufacturing each component of the connector 1 by an existing facility and assembling the manufactured components. Thus, the desired connectors 1 can be manufactured at low cost.

### Effects of Embodiment

According to the configuration of the above embodiment, the following effects can be obtained.
(1) The connector 1 is provided with the connector body 2 mounted with the busbars 6 to be electrically connected to the terminals of the mating connectors 4. The connector 1 is provided with the opening forming portion 12 integrally provided to the connector body 2 and the cover member 3 to be mounted on the connector body 2. The opening forming portion 12 forms parts of the openings 5, in which the tip portions 8 of the busbars 6 are arranged and which serve as the fitting locations of the mating connectors 4, in the connector body 2. The cover member 3 is formed separately from the connector body 2 and forms the openings 5 together with the opening forming portion 12 when being mounted on the connector body 2.

According to this configuration, the busbars 6 are separate from the connector body 2. By mounting the cover member 3 on this connector body 2, the openings 5 of the connector 1 are formed by parts of the connector body 2 and parts of the cover member 3. Thus, insert molding is not used to manufacture the connector 1, wherefore a plurality of types of connectors 1 having different opening shapes can be inexpensively manufactured using the existing facility. Therefore, a plurality of types of connectors 1 can be manufactured without requiring a large-scale change of the manufacturing facility.
(2) The mounting direction of the cover member 3 on the connector body 2 is a direction along the extension direction of the tip portions 8 of the busbars 6. The supporting mechanism 24 for supporting the cover member 3 mounted on the connector body 2 in the plane direction intersecting the mounting direction of the cover member 3 is provided between the connector body 2 and the cover member 3. According to this configuration, even if the mating connector 4 fit in the opening 5 is pried, that operation load can be supported by the supporting mechanism 24. Therefore, the detachment of the cover member 3 mounted on the connector body 2 can be made difficult.
(3) The supporting mechanism 24 includes the guiding portions 28 for guiding the insertion of the cover member 3 into the connector body 2 by the rail shapes when the cover member 3 is mounted to be inserted into the connector body 2. According to this configuration, the cover member 3 can be smoothly mounted on the connector body 2 by being guided by the guiding portions 28.
(4) The connector 1 is provided with the lock mechanism 38 for holding the cover member 3 on the connector body 2 when the cover member 3 is mounted on the connector body 2. According to this configuration, the cover member 3 mounted on the connector body 2 can be firmly fixed by the lock mechanism 38. Thus, the detachment of the cover member 3 mounted on the connector body 2 can be made difficult.
(5) The cover member 3 includes the support walls 41 for supporting the tip portions 8 of the busbars 6 in the positioned state. According to this configuration, the busbars 6 can be positioned at optimal positions by the support walls 41 of the cover member 3. Thus, the terminals of the mating connector 4 and the busbars 6 can be smoothly connected when the mating connector 4 is fit into the opening 5.
(6) The busbar 6 includes the intersecting portion 9 extending in the direction intersecting the tip portion 8 on the base end of the tip portion 8. The mounting direction of the busbar 6 into the connector body 2 is the direction along the extension direction of the intersecting portion 9 of the busbar 6. The support wall 41 projects along the mounting direction of the busbar 6 into the connector body 2. According to this configuration, since the busbar 6 is supported by the support wall 41 of the cover member 3 along the mounting direction of the busbar 6 into the connector body 2, the busbar mounted in the connector body 2 can also be made difficult to come out from the connector body 2.
(7) The connector 1 is provided with the positioning mechanisms 44 for positioning the busbars 6 with respect to the connector body 2. In the positioning mechanism 44, the projection 44a is provided on one of the connector body 2 and the busbar 6 and the recess 44b is provided in the other of these, and the busbar 6 is positioned with respect to the connector body 2 by engaging the projection 44a and the recess 44b when the busbar 6 is mounted into the connector body 2. According to this configuration, the connector body 2 can be made difficult to come out from the connector body 2 by the positioning mechanism 44.

Note that this embodiment can be modified and carried out as follows. This embodiment and the following modifications can be carried out in combination with each other without technically contradicting.
The number of the openings 5 is not limited to two and may be one, three or more. As just described, the number of the mating connectors 4 connectable to the connector 1 may be one, three or more.
The opening forming portion 12 may be shaped to form parts of the openings 5.
The mounting direction of the cover member 3 may be, for example, the same as the mounting direction of the busbars 6.
The cover member 3 may be mounted on the connector body 2, for example, from the width direction (Y-axis direction of FIG. 1 and the like).
The busbar 6 may be mounted on the connector body 2, for example, from a back side. In this way, the mounting direction of the busbars 6 may be changed to another direction other than that of the embodiment as appropriate.
The shape of the busbar 6 is not limited to a shape bent halfway many times, and may be, for example, a board shape.
The cover member 3 may be shaped to form parts of the openings 5.
The supporting mechanism 24 may include, for example, at least one of the first and second supporting portions 25, 26.
The supporting mechanism 24 may include, for example, only the guiding portions 28.
The lock mechanism 38 may be, for example, configured as a part of the guiding portion 28.
Although the present disclosure has been described with respect to the embodiment, the present disclosure is understood not to be limited to the embodiment and structures. The present disclosure also encompasses various modifications and modifications within the scope of equivalents. In addition, various combinations and forms, further other combinations and forms including only one element, more elements or less elements are also within the scope of the present disclosure and within the scope of thoughts.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a connector body mounted with a busbar to be electrically connected to a terminal of a mating connector;
an opening forming portion integrally provided to the connector body, the opening forming portion forming a part of an opening, a tip portion of the busbar being arranged in the opening, the opening serving as a fitting location of the mating connector; and
a cover member formed separately from the connector body, the cover member forming the opening together with the opening forming portion when being mounted on the connector body.

2. The connector of claim 1, wherein:
a mounting direction of the cover member on the connector body is a direction along an extension direction of the tip portion of the busbar, and
a supporting mechanism for supporting the cover member mounted on the connector body in a plane direction intersecting the mounting direction of the cover member is provided between the connector body and the cover member.

3. The connector of claim 2, wherein the supporting mechanism includes a guiding portion for guiding insertion of the cover member into the connector body by a rail shape when the cover member is mounted to be inserted into the connector body.

4. The connector of claim 1, comprising a lock mechanism for holding the cover member on the connector body when the cover member is mounted on the connector body.

5. The connector of claim 1, wherein the cover member includes a support wall for supporting the tip portion of the busbar in a positioned state.

6. The connector of claim 5, wherein:
the busbar includes an intersecting portion extending in a direction intersecting the tip portion on a base end of the tip portion,
a mounting direction of the busbar into the connector body is a direction along an extension direction of the intersecting portion of the busbar, and
the support wall projects along the mounting direction of the busbar into the connector body.

7. The connector of claim 1, comprising a positioning mechanism including a projection provided on one of the connector body and the busbar and a recess provided in the other of the connector body and the busbar, the positioning mechanism positioning the busbar with respect to the connector body by engaging the projection and the recess when the busbar is mounted into the connector body.
